(19) United States
(12) Patent Application Publication
(10) Pub. No.: US 2008/0273476 A1
(43) Pub. Date: Nov. 6, 2008

(54) Device Method and System For Teleconferencing

(76) Inventors: Menachem Cohen, Ra'ananna (IL); Ofer Milstein, Herzeliya (IL); Eli Tzirkel, Ra'ananna (IL); Ron Shpindler, Hod-Ha'Sharon (IL); Ron Wein, Herzeliya (IL); Avinoam Levi, Tel-Aviv (IL)

Correspondence Address: Naomi Assia Law Offices;C/O Landon IP Inc., Suite 450, 1700 Diagonal Road, Alexandria, VA, 22314, US

(21) Appl. No.: 11/950,526

(22) Filed: Dec. 5, 2007

Related U.S. Application Data
(60) Provisional application No. 60/915,442, filed on May 2, 2007.

(51) Int. Cl. H04L 12/16; H04L 12/18

(52) U.S. Cl. 370/260; 348/E07.083

(57) ABSTRACT

Disclosed is a device, system and method for teleconferencing. According to some embodiments of the present invention, there is provided a teleconferencing system including a communication module adapted to transmit a digital data stream including data correlated to (e.g. representative of) a sound signal received by one or more microphones from a given sound source along with a relative direction vector or a relative direction vector indicator associated with the given sound source.

### CROSS-REFERENCE TO RELATED APPLICATION

This application claims priority from U.S. Provisional Patent Application No. 60/915,442, filed May 2, 2007, which is hereby incorporated by reference in its entirety.

### FIELD OF THE INVENTION

The present invention relates generally to the field of communication. More specifically, the present invention relates to a device, system and method for facilitating teleconferencing.

### BACKGROUND

A goal of teleconferencing systems is to provide, at a remote teleconference site, a high fidelity representation of speech spoken by persons present and events occurring at a local teleconference site. A teleconferencing system that represents the local conferencing site with sufficient fidelity may enable effective communication and collaboration among teleconferencing participants despite their physical separation.

In practice, however, it is difficult to capture the persons and events at a local conferencing site effectively using a single audio feed from a single microphone. This is especially true in conferences with more than one local conferencing participant. Because of past limitations in bandwidth connecting a local and remote location of a teleconference, the number and content of audio signals transmitted between locations was limited, and the sound reproduction of the audio gave little indication, other than voice/speech parameters, as to which participant from a given site was speaking.

Attempts have been made in the prior art to address the issue of identifying speakers by acquiring, transmitting and reproducing audio in stereo. However, this approach has considerable disadvantages relating to listeners not sitting at “stereo hotspots.”

Further attempts have been made to address speaker identification issues using displays which indicate which speaker is speaking. However, these systems have drawbacks relating to system complexity and the amount of speaker involvement needed in order for the system to function effectively.

There is thus a need in the field of teleconferencing systems for an improved method, device and system for facilitating teleconferences.

### SUMMARY OF THE INVENTION

The present invention is a device, method and system for facilitating teleconferencing. According to some embodiments of the present invention, there are provided one or more sound (e.g. human voice) acquisition units, wherein each sound acquisition unit may include one or more microphones. According to some embodiments of the present invention, the one or more microphones on each sound acquisition unit may be a directional or omni-directional microphone. In situations where a sound acquisition unit includes two or more microphones, the microphones may be directional with their lobes of reception arranged to provide substantially full angular coverage (i.e. 360 degrees) around the sound acquisition unit.

Any microphone known today or to be devised in the future may be applicable to the present invention. An output electrical signal from a microphone according to some embodiment of the present invention may be correlated with a sound detected by the microphone. The output electrical signal may either be an analog signal or a digital signal. According to embodiments of the present invention where the microphone output signal is analog, the sound acquisition unit may include or be functionally associated with an analog-to-digital (“A/D”) converter to convert the analog signal output from the microphones into one or more digital data streams corresponding to the analog signal. One or more A/D's may be located either integrally with the sound acquisition unit or as part of another device or subsystem functionally associated with the sound acquisition unit.

According to some embodiments of the present invention, the output signal of each microphone on each sound acquisition unit may be digitized into a separate digital data stream. According to further embodiments of the present invention, the output signals of two or more microphones within a voice acquisition unit may be mixed, either before or after being digitized, so as to produce a single digital data stream corresponding to voice/sound signals received by the two or more microphones.

A teleconferencing system according to some embodiments of the present invention may include a communication module adapted to transmit a digital data stream including data correlated to a sound signal received by one or more microphones from a given sound source. Included with the digital data stream may be an indictor of a relative direction vector associated with the given sound source.

A signal processing block may estimate a relative direction vector associated with the given sound source based on electrical signals produced when sound signals from the given source are received by two or more microphones. According to some embodiments of the present invention, the signal processing block may include at least one cross-correlation block adapted to cross-correlate digitized output signals from two or more microphones, or from two more sets of microphones, wherein each set of microphones may either output a separate signal from each constituent microphone or may output a composite signal which is based on a mixture of constituent microphone outputs. According to some embodiments of the present invention, the cross-correlation block may cross-correlate signals received from microphones located on separate sound acquisition units.

The use of cross-correlation and other signal processing techniques and technologies for the purpose of deriving a direction vector associated with a sound source whose sound is received by multiple microphones is well known. Since according to some embodiments of the present invention the positioning of the microphones may not be fixed or even known, a direction vector derived from sound signals received by two or more microphones may not be an absolute value and may be termed a “relative direction vector.” That is, each direction vector associated with a sound source may be designated by its direction relative to the direction of another sound source or another reference direction such as a virtual axis within a virtual coordinate system based on either an arbitrary reference axis or on a reference axis correlated to an arrangement of the microphone sets relative to one another. Furthermore, since the derived direction vectors may not be absolute, but relative to each other, they may be designated or communicated using some indicator (e.g. direction vector 1, direction vector 2, position 1, position 2, etc.) rather than by using angles, magnitude or distance values—as is common for vectors. Since an indicator may not be correlated to specific directions, determining a sound source's position relative to the microphone sets may not be possible by a receiving system. It should be understood by one of skill in the art that any such technique or technology of deriving direction vectors, known today or to be derived in the future, may be applicable to the present invention.

According to some embodiments of the present invention, there may be provided a relative direction vector table adapted to store a relative direction vector for substantially each sound source detected by the signal processing block. A portion of the signal processing block may be adapted to intermittently estimate a relative direction vector associated with some or all detected sound sources, and the relative direction vector table may be updated by the signal processing block each time a relative direction vector is re-estimated.

According to further embodiments of the present invention, the signal processing block may further include (blind) source separation functionality and/or source separation segment. The signal processing block may include a processing segment adapted to perform independent component analysis on signals output from the microphones or microphone sets. According to further embodiments of the present invention, the signal processing block may include a digital matching filter adapted to output a digital data stream correlated with a given sound source by match filtering a first microphone output with a delayed output from a second microphone, where the delay on the second microphone output is associated with the relative direction vector of the given sound source. According to some embodiments of the present invention, there may be two or more matching filters, wherein each of the two or more matching filters may be adapted to output a separate digital data stream, each data stream representative of and containing data most correlated with a separate sound source.

According to further embodiments of the present invention, there may be provided a mixing stage adapted to mix microphone output signals associated with the sound source. Control logic may adjust the mixing stage configuration in order to pass signals from a microphone closest to a the source indicated by the relative direction vector, for example a dominant (e.g. loudest) sound source, while suppressing signals from one or more microphones further from the indicated sound source, for example microphones closer to less dominant sound sources or further away from the dominant sound source. According to this embodiment, content of an output data stream may be predominantly representative of the dominant sound source.

According to some embodiments of the present invention, the signal processing block may include a voice matching module adapted to match one or more voice parameters with a given sound, assuming the sound source is a person. Upon matching one or more voice parameters with a given sound source, the signal processing block may configure a digital filter to filter a signal from the given sound source based on the one or more voice parameters corresponding to the given sound source. A voice parameter table may store one or more parameters associated with the given sound source, and the signal processing block may include a voice parameter extraction module adapted to derive voice parameters from a given sound source.

The voice matching module may be used in conjunction with a relative direction vector estimation module to confirm the consistency of a given sound source (i.e. person or participant). For example, as a given relative direction vector is associated with a given sound source (i.e. given person or participant), a voice parameter extraction module may derive one or more voice parameters for the given sound source. The next time a sound is detected from a relative direction corresponding to the given relative direction vector, it may either be assumed that the sound came from the given sound source or a voice matching module may be used to compare voice parameters from the newly detected sound with voice parameters previously derived from the given sound source so as to confirm that the newly detected sound was in fact produced by the given sound source.

According to further embodiments of the present invention, a communication module may packetize a digital data stream emanating from a mixing stage into a single packet stream. The packet stream may be transmitted to a corresponding destination teleconferencing system. Included in the packet stream may be the digital data stream associated with substantially a single sound source along with the relative direction vector (or indicator of vector) corresponding to that single sound source.

According to some embodiments of the present invention, a communication module may packetize digital data streams from two or more matching filters, or from a microphone mixing stage, or from any combination of match filters and mixing stages, into a single or multiple packet stream. The packet stream may be transmitted to a corresponding destination teleconferencing system. Included in the packet stream may be one or more digital data streams, each of which digital data streams may be substantially associated with a single sound source. Along with each digital data stream in the packet stream there may be transmitted a relative direction vector, or an indicator of the relative direction vector, corresponding to the sound source with which the digital data stream is associated.

According to some embodiments of the present invention, a teleconferencing system may include a communication module adapted to receive one or more packet streams, wherein each pack stream may include one or more digital data streams, each of which digital data streams may be substantially associated with a single sound source. Each digital data stream may be received by the communication module along with a relative direction vector, or an indicator of the relative direction vector, corresponding to the sound source with which the digital data stream is associated.

According to some embodiments of the present invention, a teleconferencing system may include a set of analog or digital speakers. Analog speakers are well known in the art of sound reproduction, and any such speakers known today or to be devised in the future may be applicable to the present invention. Digital speakers comprised of arrays of piezoelectric actuators/transducers are a recent invention and described in several published patent applications and articles. Any digital speakers known today or to be devised in the future may be applicable to the present invention.

According to some embodiments of the present invention, separate digital data streams may be rendered differently across a set of speakers. For example, a first received digital data stream substantially representative of sound generated by a first sound source may be rendered across a first subset of speakers, while a second digital data stream substantially representative of sound generated by a second sound source may be rendered across a second subset of speakers, which second subset may be partially overlapping with the first subset (e.g. First Subset=speakers 1, 2 and 3 & Second Subset=speakers 3 and 4). More complex rendering schemes for a given digital data stream may include varying the volume or phase at which the given data stream is rendered across a set of subset of speakers (e.g. Speaker 1=50% of max, Speaker 2=100% of max, Speaker 3=100% of max and Speaker 4=50% of max). According to further embodiments, a single data stream may be rendered according to an associated indicator. If the indicator associated with the stream changes, so may the rendering scheme.

A teleconferencing system according to some embodiments of the present invention may include a synthetic rendering module. The synthetic rendering module may be adapted to facilitate a different and/or unique rendering scheme to audio content contained in different digital data streams. A rendering scheme according to some embodiments of the present invention may be defined as a combination of output settings (e.g. volume per speaker: 0% to 100% of max) for a given digital data stream being rendered through a set of speakers.

The synthetic rendering module may include or be functionally associated with a rendering table, wherein the rendering table may include information correlating a given relative direction vector or relative direction vector indicator, associated a given digital data stream, with a specific rendering scheme. For a received digital data stream, the synthetic rendering module may cross reference the received stream's relative direction vector or relative direction vector indicator with a rendering scheme in the rendering table. The rendering module may then signal an audio output module to render the received digital data stream in accordance with the cross-referenced scheme in the rendering table. According to some embodiments of the present invention, the rendering table may contain a separate rendering scheme entry for each of a set of data streams received substantially concurrently, and the rendering module may signal the audio output module to currently render each received data stream according to a separate rendering scheme.

The audio output module may include one or more adjustable signal conditioning circuits adapted to condition and generate output signals based on each of the received digital data streams. Conditioning circuits may include Digital to Analog (“D/A”) converters, fixed and adjustable amplifiers, adjustable signal attenuators, signal switches and signal mixers.

According to embodiments of the present invention associated with a set of analog speakers, one or more digital to analog (“D/A”) converter(s) may be adapted to convert a received digital data stream into an analog signal representative of the sound source associated with the received digital data stream. According to some embodiments of the present invention, each of a set of D/A's may convert a separate digital data stream into a separate analog signal, wherein a given analog signal is substantially representative of the sound source or sources associated with the digital data stream based on which the given analog signal is generated. Digitally adjustable mixing circuit or circuits may vary the application of a D/A output to each of the speakers in accordance with signaling, for example signaling from a synthetic rendering module. According to some embodiments, the mixing circuit may include or be functionally associated with a set of digitally adjustable amplifiers. According to alternative embodiments, the mixing circuit may include or be functionally associated with a set of digitally adjustable signal attenuators.

According to alternative embodiments of the present invention, where the speakers adapted to deceive digital signals, the signal conditioning circuit(s) may include digital switches and/or signal processing logic.

Various methods, circuits and systems for adjustable signal conditioning/mixing, both analog and digital, are well known. Any such method, circuit or system known today or to be devised in the future may be applicable to the audio output module of the present invention.

According to some embodiments of the present invention, a rendering scheme allocation module may assign a rendering scheme to a given data stream either: (1) arbitrarily, (2) based on order of first arrival, or (3) based on some digital data stream parameter. Digital data stream parameters based on which a rendering scheme may be assigned may include: (1) data stream priority values included in an indicator associated with the data stream, (2) relative data stream volume (e.g. dominant participants get dominant rendering schemes), (3) voice signature/parameters, (4) rendering schemes occupancy, (5) physical distance between speakers etc. A data stream analysis module may provide the rendering scheme allocation module with digital data steam parameters associated with substantially each received digital data stream.

The rendering scheme allocation module may allocate and record in the rendering table a rendering scheme for a given data stream upon that data stream's first instance (i.e. the first time a data stream with the given data stream's indicator is received) during a teleconferencing session. According to some embodiments of the present invention, a given data stream may retain the same rendering scheme through an entire teleconferencing session. According to alternative embodiments of the present invention, the rendering scheme allocation module may update the rendering scheme for a given data stream should the given data stream's parameters relative value change during the session.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a functional block diagram of a teleconferencing system according to some embodiments of the present invention;

FIG. 2 shows a functional block diagram of a teleconferencing system according to some embodiments of the present invention;

FIG. 3 shows a functional block diagram of a teleconferencing system according to yet further embodiments of the present invention;

FIG. 4 shows a functional block diagram of a teleconference system according to some embodiments of the present invention;

FIG. 5 is a flow charting including steps of an exemplary method in accordance with some embodiments of the present invention for acquiring, filtering and transmitting sound from one or more sound sources;

FIGS. 6A, 6B and 6C are functional block diagrams of a digital signal processing block in accordance with some embodiments of the present invention;

FIG. 7 shows a functional block diagram of a teleconference subsystem according to some embodiments of the present invention;

FIG. 8 shows a functional block diagram of a sound rendering system according to a further embodiment of the present invention.

FIG. 9 is a flow charting including steps of an exemplary method in accordance with some embodiments of the present invention for rendering sounds acquired from one or more sound sources;

FIG. 10 is a functional block diagram of a digital signal processing block in accordance with some embodiments of the present invention;

FIGS. 11A, 11B and 11C are diagrams of a teleconference subsystem in accordance with some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a device, method and system for facilitating teleconferencing. According to some embodiments of the present invention, there are provided one or more sound (e.g. human voice) acquisition units, wherein each sound acquisition unit may include one or more microphones. According to some embodiments of the present invention, the one or more microphones on each sound acquisition unit may be a directional or omni-directional microphone. In situations where a sound acquisition unit includes two or more microphones, the microphones may be directional with their lobes of reception arranged to provide substantially full angular coverage (i.e. 360 degrees) around the sound acquisition unit.

Any microphone known today or to be devised in the future may be applicable to the present invention. An output electrical signal from a microphone according to some embodiment of the present invention may be correlated with a sound detected by the microphone. The output electrical signal may either be an analog signal or a digital signal. According to embodiments of the present invention where the microphone output signal is analog, the sound acquisition unit may include or be functionally associated with an analog-to-digital (“A/D”) converter to convert the analog signal output from the microphones into one or more digital data streams corresponding to the analog signal. One or more A/D's may be located either integrally with the sound acquisition unit or as part of another device or subsystem functionally associated with the sound acquisition unit.

According to some embodiments of the present invention, the output signal of each microphone on each sound acquisition unit may be digitized into a separate digital data stream. According to further embodiments of the present invention, the output signals of two or more microphones within a voice acquisition unit may be mixed, either before or after being digitized, so as to produce a single digital data stream corresponding to voice/sound signals received by the two or more microphones.

A teleconferencing system according to some embodiments of the present invention may include a communication module adapted to transmit a digital data stream including data correlated to a sound signal received by one or more microphones from a given sound source. Included with the digital data stream may be an indictor of a relative direction vector associated with the given sound source.

A signal processing block may estimate a relative direction vector associated with the given sound source based on electrical signals produced when sound signals from the given source are received by two or more microphones. According to some embodiments of the present invention, the signal processing block may include at least one cross-correlation block adapted to cross-correlate digitized output signals from two or more microphones, or from two more sets of microphones, wherein each set of microphones may either output a separate signal from each constituent microphone or may output a composite signal which is based on a mixture of constituent microphone outputs. According to some embodiments of the present invention, the cross-correlation block may cross-correlate signals received from microphones located on separate sound acquisition units.

The use of cross-correlation and other signal processing techniques and technologies for the purpose of deriving a direction vector associated with a sound source whose sound is received by multiple microphones is well known. Since according to some embodiments of the present invention the positioning of the microphones may not be fixed or even known, a direction vector derived from sound signals received by two or more microphones may not be an absolute value and may be termed a “relative direction vector.” That is, each direction vector associated with a sound source may be designated by its direction relative to the direction of another sound source or another reference direction such as a virtual axis within a virtual coordinate system based on either an arbitrary reference axis or on a reference axis correlated to an arrangement of the microphone sets relative to one another. Furthermore, since the derived direction vectors may not be absolute, but relative to each other, they may be designated or communicated using some indicator (e.g. direction vector 1, direction vector 2, position 1, position 2, etc.) rather than by using angles, magnitude or distance values—as is common for vectors. Since an indicator may not be correlated to specific directions, determining a sound source's position relative to the microphone sets may not be possible by a receiving system. It should be understood by one of skill in the art that any such technique or technology of deriving direction vectors, known today or to be derived in the future, may be applicable to the present invention.

According to some embodiments of the present invention, there may be provided a relative direction vector table adapted to store a relative direction vector for substantially each sound source detected by the signal processing block. A portion of the signal processing block may be adapted to intermittently estimate a relative direction vector associated with some or all detected sound sources, and the relative direction vector table may be updated by the signal processing block each time a relative direction vector is re-estimated.

According to further embodiments of the present invention, the signal processing block may further include (blind) source separation functionality. The signal processing block may include a processing segment adapted to perform independent component analysis on signals output from the microphones or microphone sets. According to further embodiments of the present invention, the signal processing block may include a digital matching filter adapted to output a digital data stream correlated with a given sound source by match filtering a first microphone output with a delayed output from a second microphone, where the delay on the second microphone output is associated with the relative direction vector of the given sound source. According to some embodiments of the present invention, there may be two or more matching filters, wherein each of the two or more matching filters may be adapted to output a separate digital data stream, each data stream representative of and containing data most correlated with a separate sound source.

According to further embodiments of the present invention, there may be provided a mixing stage adapted to mix microphone output signals associated with the sound source. Control logic may adjust the mixing stage configuration in order to pass signals from a microphone closest to a the source indicated by the relative direction vector, for example a dominant (e.g. loudest) sound source, while suppressing signals from one or more microphones further from the indicated sound source, for example microphones closer to less dominant sound sources or further away from the dominant sound source. According to this embodiment, content of an output data stream may be predominantly representative of the dominant sound source.

According to some embodiments of the present invention, the signal processing block may include a voice matching module adapted to match one or more voice parameters with a given sound, assuming the sound source is a person. Upon matching one or more voice parameters with a given sound source, the signal processing block may configure a digital filter to filter a signal from the given sound source based on the one or more voice parameters corresponding to the given sound source. A voice parameter table may store one or more parameters associated with the given sound source, and the signal processing block may include a voice parameter extraction module adapted to derive voice parameters from a given sound source.

The voice matching module may be used in conjunction with a relative direction vector estimation module to confirm the consistency of a given sound source (i.e. person or participant). For example, as a given relative direction vector is associated with a given sound source (i.e. given person or participant), a voice parameter extraction module may derive one or more voice parameters for the given sound source. The next time a sound is detected from a relative direction corresponding to the given relative direction vector, it may either be assumed that the sound came from the given sound source or a voice matching module may be used to compare voice parameters from the newly detected sound with voice parameters previously derived from the given sound source so as to confirm that the newly detected sound was in fact produced by the given sound source.

According to further embodiments of the present invention, a communication module may packetize a digital data stream emanating from a mixing stage into a single packet stream. The packet stream may be transmitted to a corresponding destination teleconferencing system. Included in the packet stream may be the digital data stream associated with substantially a single sound source along with the relative direction vector (or indicator of vector) corresponding to that single sound source.

According to some embodiments of the present invention, a communication module may packetize digital data streams from two or more matching filters, or from a microphone mixing stage, or from any combination of match filters and mixing stages, into a single or multiple packet stream. The packet stream may be transmitted to a corresponding destination teleconferencing system. Included in the packet stream may be one or more digital data streams, each of which digital data streams may be substantially associated with a single sound source. Along with each digital data stream in the packet stream there may be transmitted a relative direction vector, or an indicator of the relative direction vector, corresponding to the sound source with which the digital data stream is associated.

According to some embodiments of the present invention, a teleconferencing system may include a communication module adapted to receive one or more packet streams, wherein each pack stream may include one or more digital data streams, each of which digital data streams may be substantially associated with a single sound source. Each digital data stream may be received by the communication module along with a relative direction vector, or an indicator of the relative direction vector, corresponding to the sound source with which the digital data stream is associated.

According to some embodiments of the present invention, a teleconferencing system may include a set of analog or digital speakers. Analog speakers are well known in the art of sound reproduction, and any such speakers known today or to be devised in the future may be applicable to the present invention. Digital speakers comprised of arrays of piezoelectric actuators/transducers are a recent invention and described in several published patent applications and articles. Any digital speakers known today or to be devised in the future may be applicable to the present invention.

According to some embodiments of the present invention, separate digital data streams may be rendered differently across a set of speakers. For example, a first received digital data stream substantially representative of sound generated by a first sound source may be rendered across a first subset of speakers, while a second digital data stream substantially representative of sound generated by a second sound source may be rendered across a second subset of speakers, which second subset may be partially overlapping with the first subset (e.g. First Subset=speakers 1, 2 and 3 & Second Subset=speakers 3 and 4). More complex rendering schemes for a given digital data stream may include varying the volume or phase at which the given data stream is rendered across a set of subset of speakers (e.g. Speaker 1=50% of max, Speaker 2=100% of max, Speaker 3=100% of max and Speaker 4=50% of max). According to further embodiments, a single data stream may be rendered according to an associated indicator. If the indicator associated with the stream changes, so may the rendering scheme.

A teleconferencing system according to some embodiments of the present invention may include a synthetic rendering module. The synthetic rendering module may be adapted to facilitate a different and/or unique rendering scheme to audio content contained in different digital data streams. A rendering scheme according to some embodiments of the present invention may be defined as a combination of output settings (e.g. volume per speaker: 0% to 100% of max) for a given digital data stream being rendered through a set of speakers.

The synthetic rendering module may include or be functionally associated with a rendering table, wherein the rendering table may include information correlating a given relative direction vector or relative direction vector indicator, associated a given digital data stream, with a specific rendering scheme. For a received digital data stream, the synthetic rendering module may cross reference the received stream's relative direction vector or relative direction vector indicator with a rendering scheme in the rendering table. The rendering module may then signal an audio output module to render the received digital data stream in accordance with the cross-referenced scheme in the rendering table. According to some embodiments of the present invention, the rendering table may contain a separate rendering scheme entry for each of a set of data streams received substantially concurrently, and the rendering module may signal the audio output module to currently render each received data stream according to a separate rendering scheme.

The audio output module may include one or more adjustable signal conditioning circuits adapted to condition and generate output signals based on each of the received digital data streams. Conditioning circuits may include Digital to Analog (“D/A”) converters, fixed and adjustable amplifiers, adjustable signal attenuators, signal switches and signal mixers.

According to embodiments of the present invention associated with a set of analog speakers, one or more digital to analog (“D/A”) converter(s) may be adapted to convert a received digital data stream into an analog signal representative of the sound source associated with the received digital data stream. According to some embodiments of the present invention, each of a set of D/A's may convert a separate digital data stream into a separate analog signal, wherein a given analog signal is substantially representative of the sound source or sources associated with the digital data stream based on which the given analog signal is generated. Digitally adjustable mixing circuit or circuits may vary the application of a D/A output to each of the speakers in accordance with signaling, for example signaling from a synthetic rendering module. According to some embodiments, the mixing circuit may include or be functionally associated with a set of digitally adjustable amplifiers. According to alternative embodiments, the mixing circuit may include or be functionally associated with a set of digitally adjustable signal attenuators.

According to alternative embodiments of the present invention, where the speakers adapted to deceive digital signals, the signal conditioning circuit(s) may include digital switches and/or signal processing logic.

Various methods, circuits and systems for adjustable signal conditioning/mixing, both analog and digital, are well known. Any such method, circuit or system known today or to be devised in the future may be applicable to the audio output module of the present invention.

According to some embodiments of the present invention, a rendering scheme allocation module may assign a rendering scheme to a given data stream either: (1) arbitrarily, (2) based on order of first arrival, or (3) based on some digital data stream parameter. Digital data stream parameters based on which a rendering scheme may be assigned may include: (1) data stream priority values included in an indicator associated with the data stream, (2) relative data stream volume (e.g. dominant participants get dominant rendering schemes), (3) voice signature/parameters, (4) rendering schemes occupancy, (5) physical distance between speakers etc. A data stream analysis module may provide the rendering scheme allocation module with digital data steam parameters associated with substantially each received digital data stream.

The rendering scheme allocation module may allocate and record in the rendering table a rendering scheme for a given data stream upon that data stream's first instance (i.e. the first time a data stream with the given data stream's indicator is received) during a teleconferencing session. According to some embodiments of the present invention, a given data stream may retain the same rendering scheme through an entire teleconferencing session. According to alternative embodiments of the present invention, the rendering scheme allocation module may update the rendering scheme for a given data stream should the given data stream's parameters relative value change during the session.

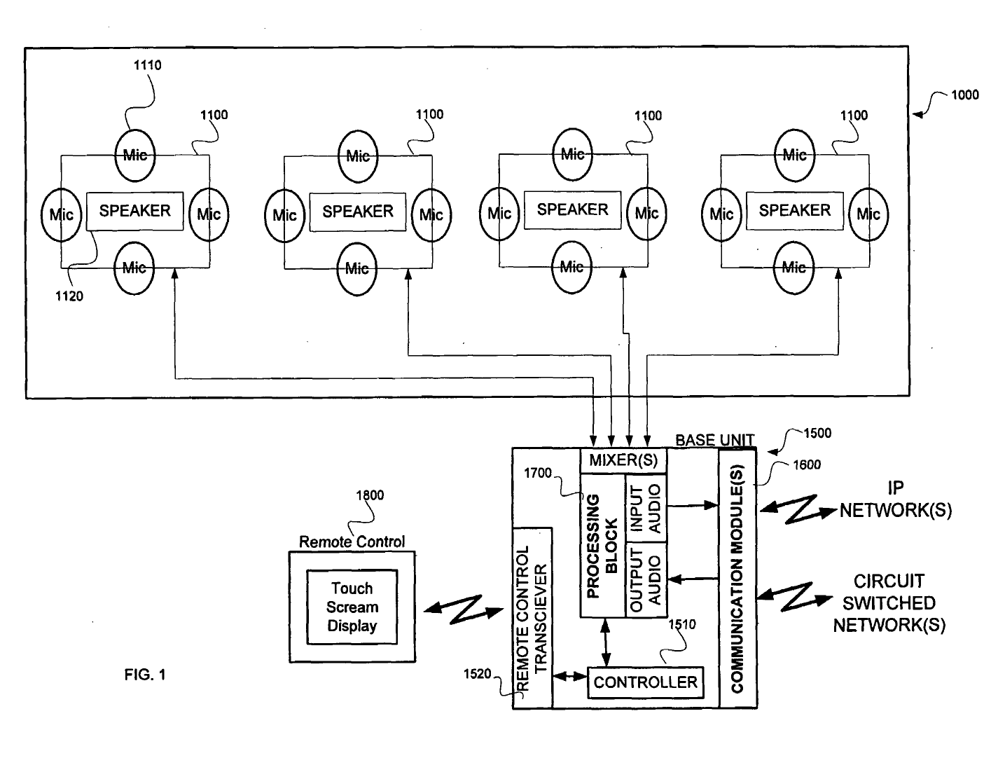

Turning now to FIG. 1, there is shown a teleconference unit (1000) for facilitating teleconference in accordance with some embodiments of the present invention. According to some embodiments of the present invention, a teleconference unit 1000 may comprise of a set of audio units (1100). According to some further embodiments of the present invention, an audio unit may comprise a set of microphones (1110) and a speaker (1120).

According to some embodiments of the present invention, unit 1100 may be connected to a base unit 1500. According to some embodiments of the present invention, base unit 1500 may comprise a processing block (1700), a controller (1510), a communication module (1600), and a remote control transceiver (1520).

According to some embodiments of the present invention, the remote control transceiver may be controlled using a remote control (1800).

According to some embodiments of the present invention, the communication modules may transmit data to IP networks, other VoIP devices such as IP phones, and/or to circuit switched networks.

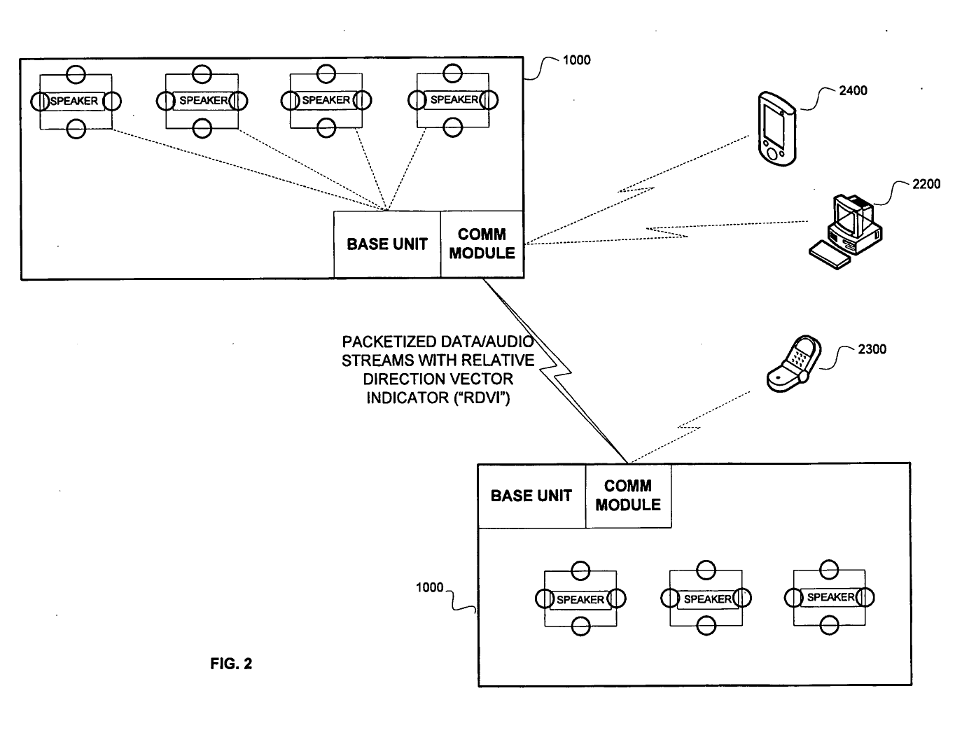

Turning now to FIG. 2, there is shown an exemplary embodiment of the present invention. According to some embodiments of the present invention, two teleconference units 1000 may send and receive packetized audio streams with relative direction vector indicator (“RDVI”).

According to some embodiments of the present invention, a teleconference unit 1000 may also send and/or receive data from other communication devices (i.e. PC 2000, cellular phone 2300 and a PDA 2400).

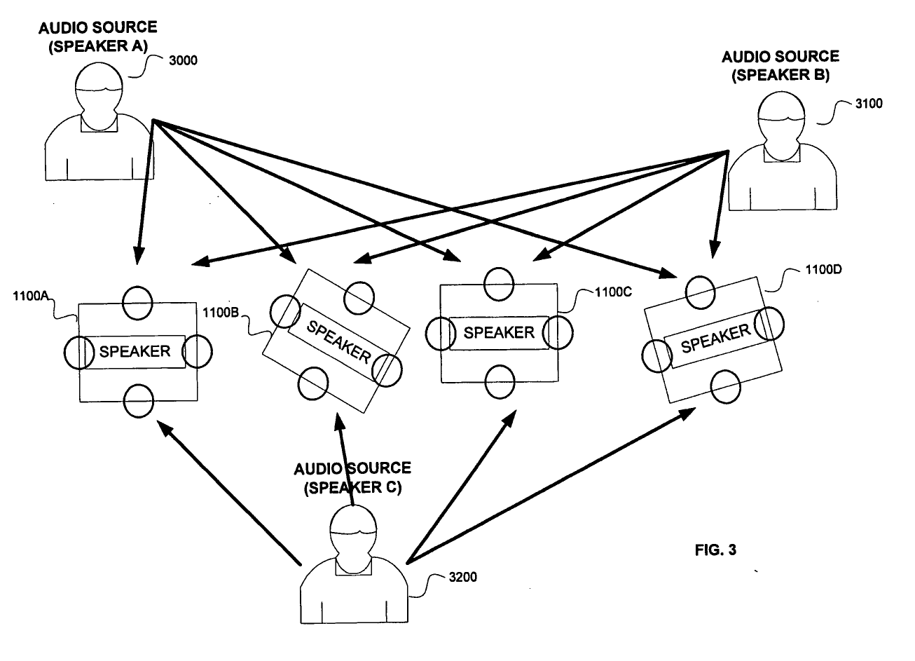

Turning now to FIG. 3 there is shown an exemplary embodiment of the present invention. According to some embodiments of the present invention, an audio source (3000, 3100 and 3200) may generate an audio signal (i.e. human voice speech), which audio signal may be sensed by one or more microphones 1110 of one or more audio units 1100 and converted to an electrical signal.

According to some embodiments of the present invention, the audio signal generated by an audio source (i.e. speaker A 3000, speaker B 3100, speaker C 3300) may be sensed by a subset of microphones of unit 1100A, a subset of microphones of unit 1100B, a subset of microphones of unit 1100C and/or a subset of microphones of unit 1100D.

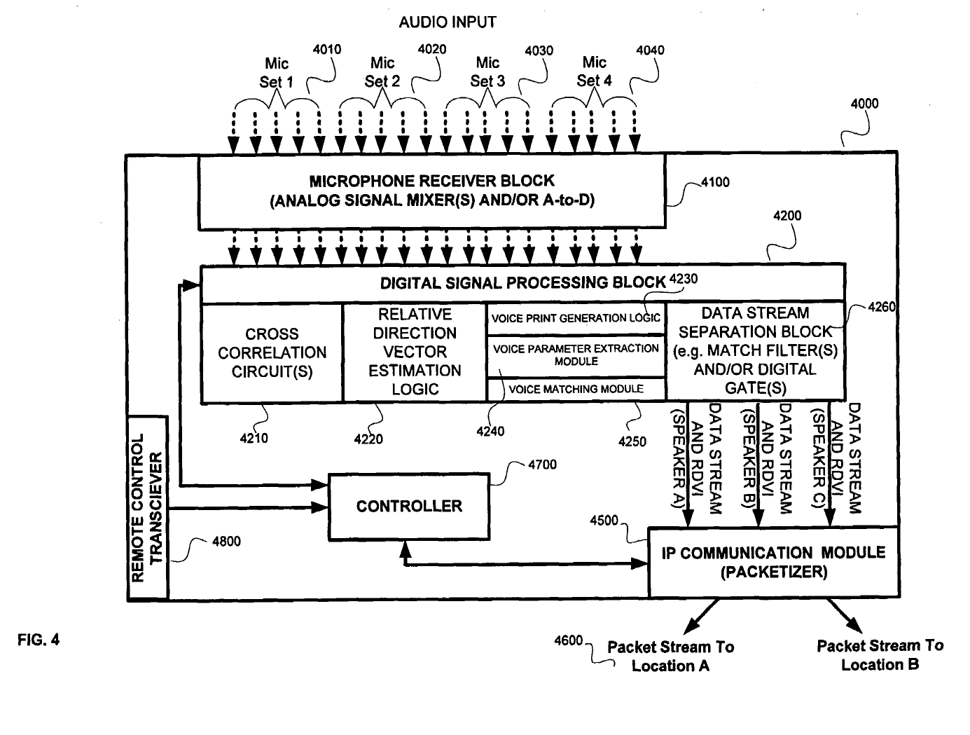

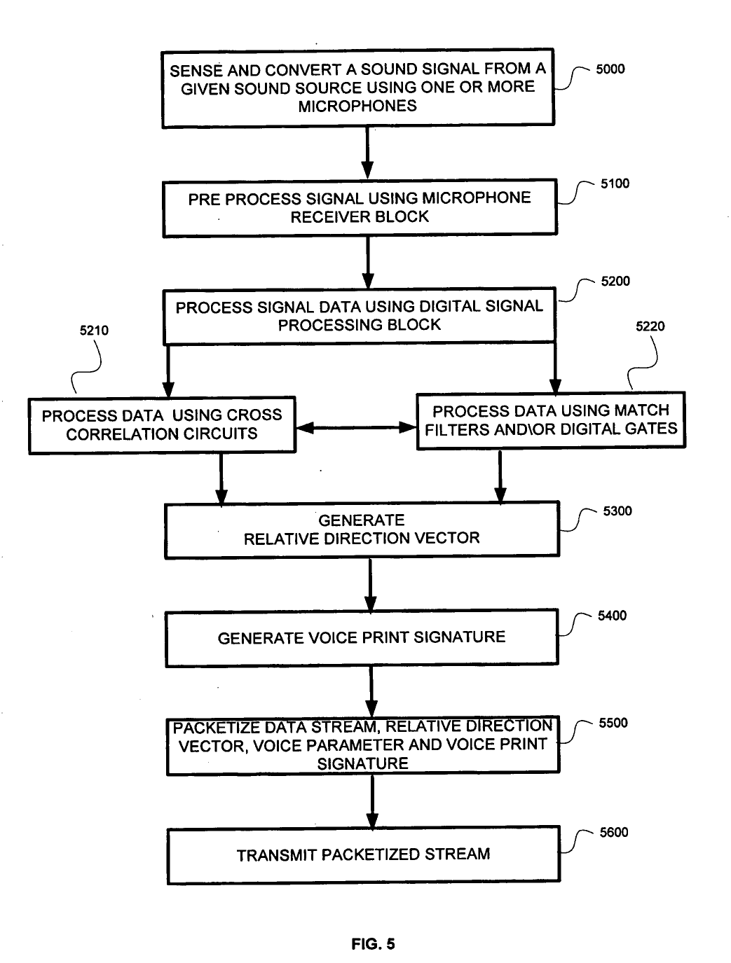

Turning now to FIG. 4, there is shown a detailed embodiment of a teleconference unit (4000) in accordance with some embodiments of the present invention. The functionality of unit 4000 may be best described in correlation with FIG. 5, there is depicted a flow chart showing the steps of an exemplary embodiment in accordance with the present invention.

According to some embodiments of the present invention, an audio sound signal from a given sound source may be sensed and converted by one or more microphones (step 5000), According to yet further embodiments of the present invention, the microphones may be associated with a set of microphones (4010, 4020, 4030 and 4040) which microphone set was described in detail hereinabove in correlation with unit 1100.

According to some embodiments of the present invention, the signal may be pre-processed using a microphone receiver block 4100 (step 5100). According to some embodiments of the present invention, microphone receiver block 4100 may comprise Analog to Digital components and/or analog signal mixers and/or analog signal filters.

According to some embodiments of the present invention, the signal data may be processed using a digital signal processing block 4200 (step 5200). According to some embodiments of the present invention the digital signal processing block may comprise summers, digital filter, cross correlation circuits 4210, IIR filters, peak finding units, normalization units, a relative direction vector estimation logic 4220, a voice print generation logic 4230, a voice parameter extraction module, 4240 and a voice matching module 4250.

According to some embodiments of the present invention, the signal data may be processed using cross correlation circuits 4210 and using match filters and/or digital gates 4260 (steps 5210 and 5220), a detailed exemplary embodiment of such processing is described herein below.

According to some embodiments of the present invention, a relative direction vector (“RDV”) may be generated using a relative direction vector estimation logic 4220 (step 5300), a detailed exemplary embodiment of such processing is described herein below.

According to some embodiments of the present invention, a voice print signature may be generated using a voice print generation logic block 4230 (step 5400).

According to yet further embodiments of the present invention, the generation of a voice print signature is done by creating for each well-identified participant direction, a signal model of the vocal system of the participant using a voice matching module 4250 and/or a voice parameter extraction module 4240.

According to some embodiments of the present invention, modeling is performed in an on-line fashion and transparently to the participants, i.e. without explicitly asking for a voice sample and with no need for the speaker identity. According to some further embodiments of the present invention, when a model is created it is used to provide further information for separating participant directions. Methods for building a model of the vocal system are known in the art of speaker-verification.

According to some embodiments of the present invention, the processed data stream along with an RDV, a voice print signature and/or a voice parameter may be packetized using an IP communication module 4500 and transmitted to remote locations 4600 (steps 5500 and 5600).

According to some embodiments of the present invention, unit 4000 may comprise a controller 4700 and a remote control transceiver 4800.

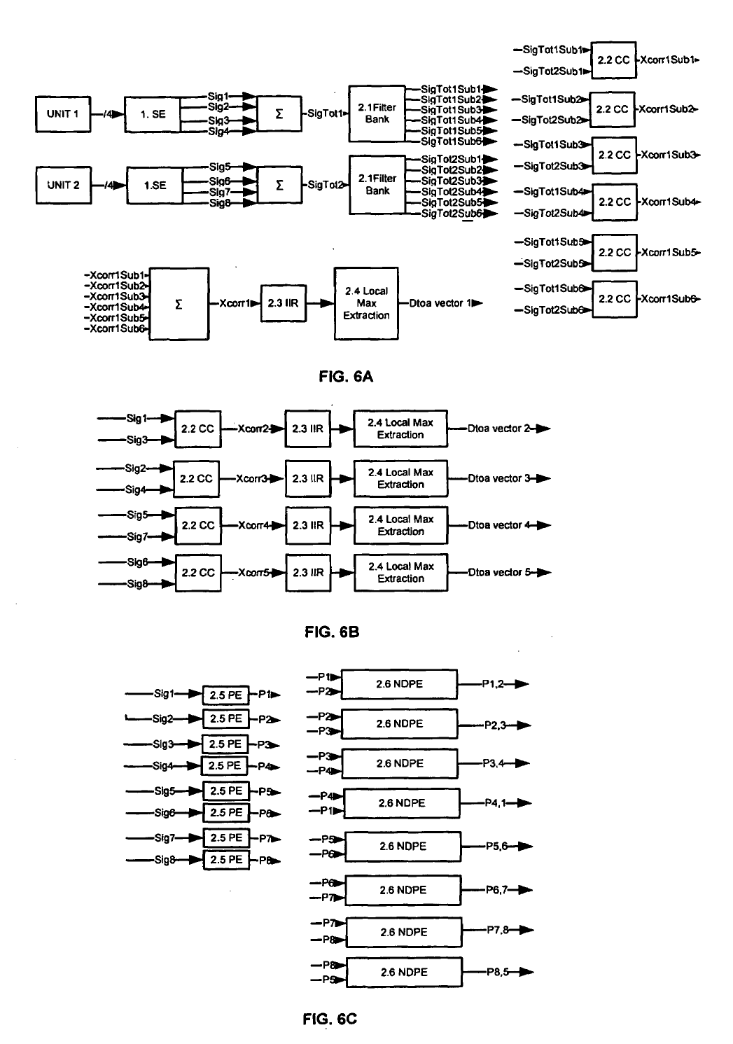

Turning now to FIG. 6A, there is shown an exemplary embodiment of a portion of the digital processing block 4200. According to some embodiments of the present invention, the signal of the four microphones of each unit may be summed up by summers (denoted Σ).

According to yet further embodiments of the present invention, a sub-band analysis may be applied by a filter-bank for each unit at frequency bands, an exemplary frequency bands may be: (a) 100 Hz-1 KHz, (b) 1-2 KHz, (c) 2-3 KHz, (c) 3-4 KHz, (d) 4-5 KHz (e) 5-6 KHz.

According to yet further embodiments of the present invention, the Sub band analysis may improve performance due to room reverberation, which room reverberation behaves very differently at different wavelengths associated with different frequencies.

According to yet further embodiments of the present invention, the correlation units (as seen also in block 4210), denoted CC, perform cross correlation in each sub-band.

According to some embodiments of the present invention, the cross-correlations of the sub-bands are added up by the summer Σ and then smoothed out by an IIR filter, denoted IIR. Finally, the peak-finding unit denoted ‘Local Max Extraction’ finds the time-location of the first five cross-correlation peaks.

According to yet further embodiments of the present invention, the first five cross-correlation peaks may correspond to arrival time differences of different participants and/or time differences between the first arrival and reflections from room surfaces.

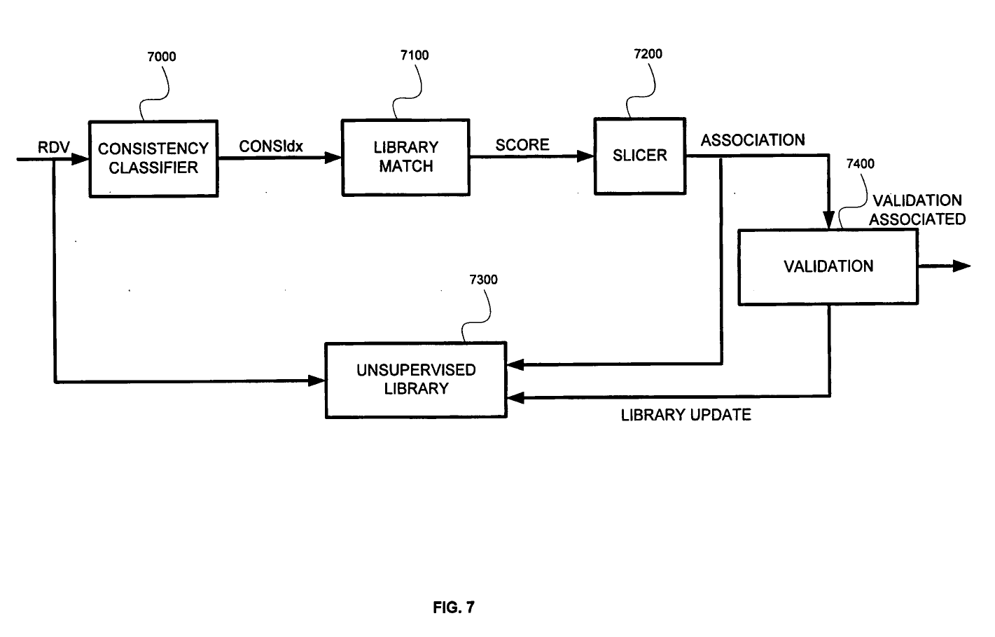

According to yet further embodiments of the present invention, the vector containing the five peaks may be defined as a directional vector and may be sent to the classifier in FIG. 7.

For efficiency reasons, sub-band filtering and cross-correlations are performed in the frequency domain using the fast Fourier transform.

Turning now to FIG. 6B, there is shown yet another exemplary embodiment of a portion of the digital processing block 4200. According to some embodiments of the present invention, the correlation units CC (as described in block 4210) compute the cross-correlation between opposite microphone pairs of each audio unit.

According to yet further embodiments of the present invention, the cross correlation may smoothed out by IIR filters (associated also with block 4260). According to yet further embodiments of the present invention, Peak-finding units may find the time-location of the first five cross-correlation peaks.

According to yet further embodiments of the present invention, the peak finding units may also be associated with logic block 4240 “voice parameter extraction module”.

According to some embodiments of the present invention, a direction vector is derived from the peak points (as described hereinabove). According to yet further embodiments of the present invention, the direction vectors derived this way may provide a different geometrical perspective and resolution from the one derived by the method described in FIG. 6A.

Turning now to FIG. 6C, there is shown yet another exemplary embodiment of a portion of the digital processing block 4200. According to some embodiments of the present invention, power estimators (denoted PE) may compute power differences between adjacent microphones located in the same audio unit. According to some embodiments of the present invention, a PE may be associated with logic block 4260 “data stream separation block (e.g. match filters and/or digital gates)”.

According to some embodiments of the present invention, the power differences may be normalized by the total power of the same microphones using normalization units (denoted NDPE). According to some embodiments of the present invention, NDPE units may be associated with logic block 4260.

According to some embodiments of the present invention, the embodiment described in FIG. 6C takes advantage of microphone directivity to complement the time-difference based features.

Turning now to FIG. 7, there is shown a detailed embodiment of logic block 4220 “relative direction vector estimation logic”.

According to some embodiments of the present invention and as described hereinabove, the system may produce several “direction vector” using different processing methods.

According to some embodiments of the present invention, block 4220 may determine which direction vector may achieve the best performances.

According to some embodiments of the present invention, the direction vectors are individually examined for consistency by the consistency classifier 7000. A vector is considered consistent if its values are similar for a number of consecutive frames allowing for some glitch.

According to some embodiments of the present invention, if the vectors are not consistent they are not used for direction classification.

According to some further embodiments of the present invention, consistent vectors may be entered to a library match 7100, where for each existing direction a match score is computed based on a statistical model.

According to some embodiments of the present invention, a slicer 7200 may consider the direction scores and may take a decision regarding which directions are associated with the frame.

According to some embodiments of the present invention, the statistical model associating feature values with a given direction is a Gaussian mixture. According to yet further embodiments of the present invention, if the scores are low, the slicer may associate a new direction for the frame.

According to some embodiments of the present invention, a maximum likelihood unsupervised learning block 7300 may be implemented to update the models stored in the library. Learning exploits the direction associations made by the slicer for each frame. According to some embodiments of the present invention, if a new direction is found, a new model is created in the library.

According to some embodiments of the present invention, the validation process may implements a state machine to ensure the slicer decision is consistent with directions identified for previous frames.

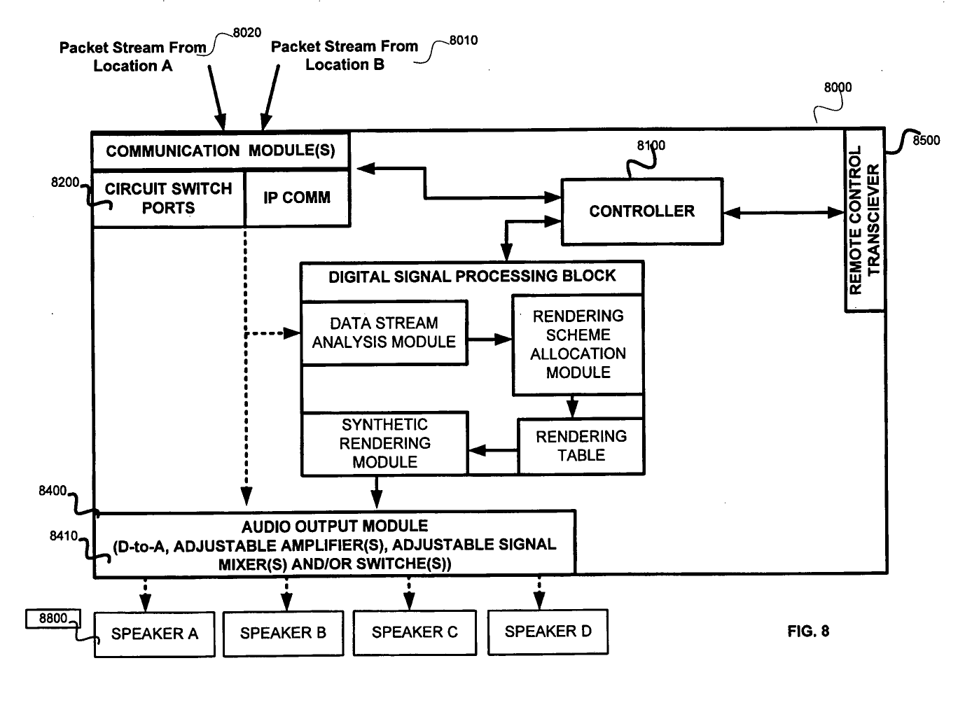

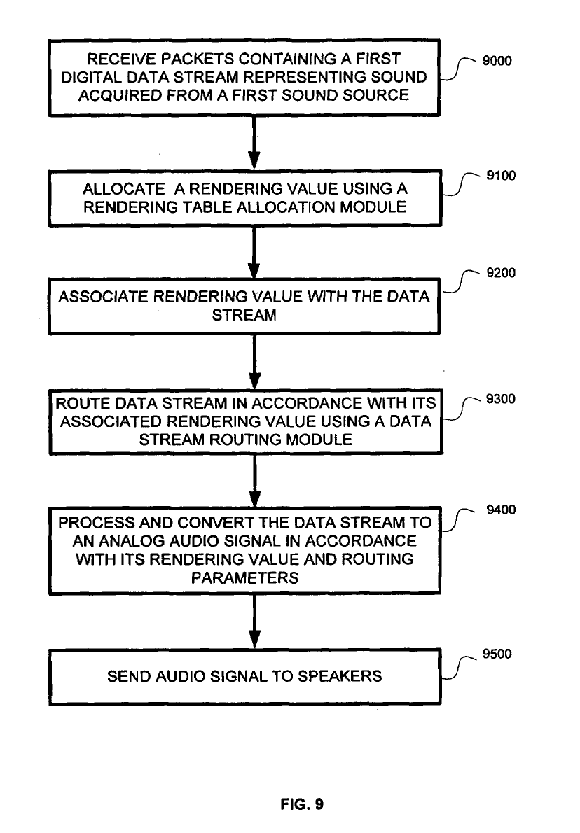

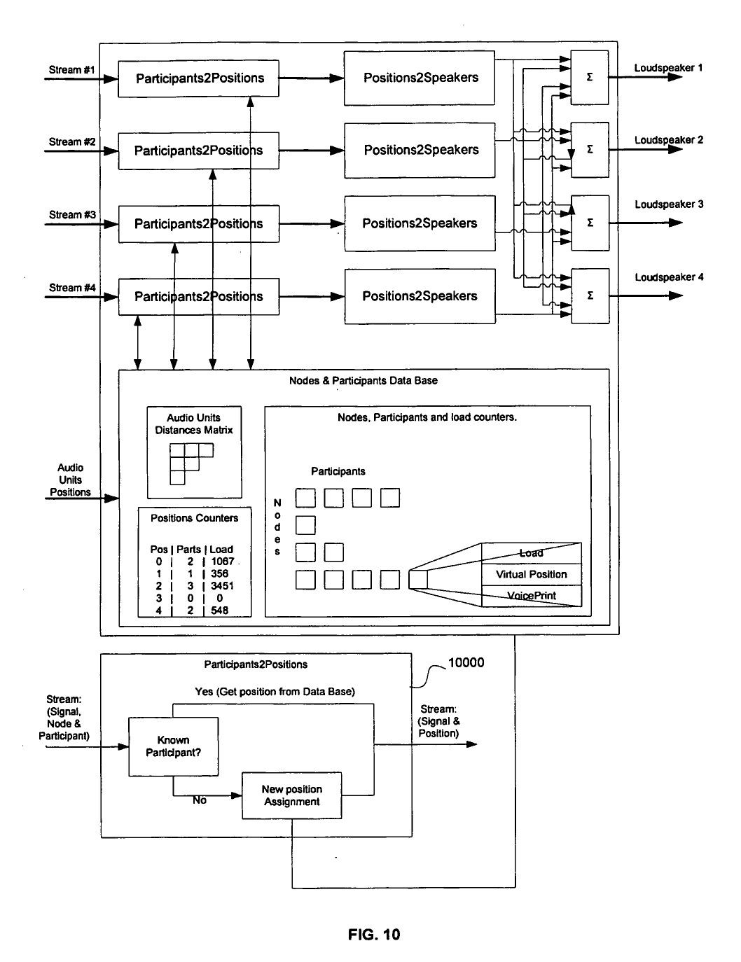

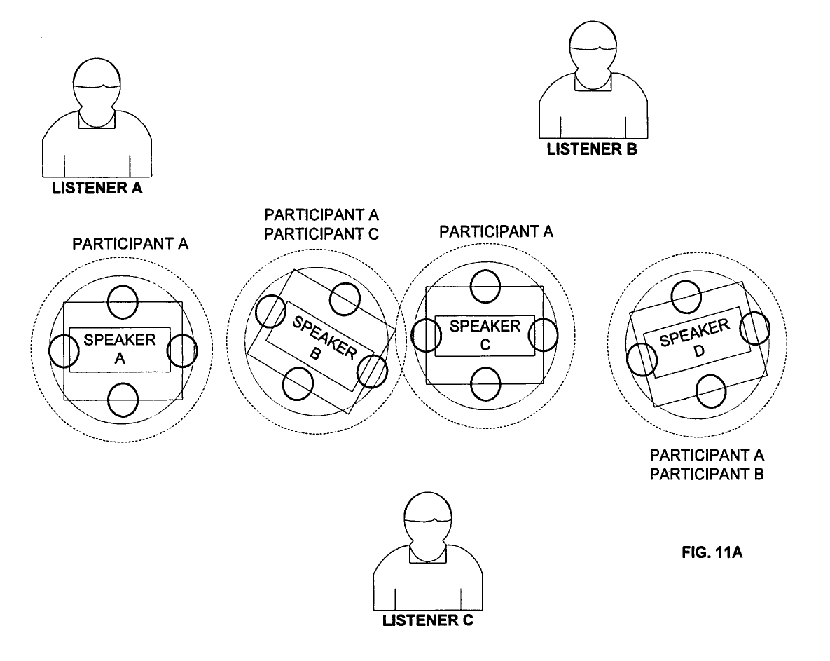

Turning now to FIG. 8, there is shown a detailed embodiment of a teleconference unit (8000) in accordance with some embodiments of the present invention. The functionality of unit 8000 may be best described in correlation with FIG. 9, there is depicted a flow chart showing the steps of an exemplary embodiment in accordance with the present invention.

According to some embodiments of the present invention, a communication module (8200) may be adapted to receive packets from one or more remote locations (8010, 8020). According to some further embodiments of the present invention, the received packets (data stream) may represent sound acquired from a first sound source (step 9000).

According to some embodiments of the present invention, the received data stream was generated using one of the methods described herein above.

According to some embodiments of the present invention, communication module 8200 may comprise circuit switch ports and/or IP communication logic block.

According to some embodiments of the present invention, the data stream may be processed by a Digital Signal Processing (“DSP”) Block 8300. According to yet further embodiments of the present invention, the DSP block 8300 may comprise of a synthetic rendering module 8350, the functionality of module 8350 is described in details herein below.

According to some embodiments of the present invention, the synthetic rendering module may comprise a data stream routing module (8360) and a rendering table allocation module (8370).

According to some embodiments of the present invention, the rendering table allocation module (8370) may comprise a rendering table, also referred sometimes as a “mapping table” or a “rendering mapping table”.

According to some embodiments of the present invention, the rendering table may be a look-up table which assigns a rendering (mapping) value to a data stream based on a parameter the data stream comprises.

According to some embodiments of the present invention, a parameter of the data stream may be any parameter which was described hereinabove, i.e. RDVI, voice print signature, priority parameter and/or any other parameter extracted from the data stream.

According to some embodiments of the present invention, the table may be accessed using a hash function, a search algorithm and/or any other look-up algorithm known today or to be devised in the future.

According to some embodiments of the present invention, the synthetic rendering module may allocate a rendering value (also referred sometimes as rendering parameter) using the rendering table allocation module (step 9100). The allocation of a rendering value is described at length herein below.

According to some embodiments of the present invention, the synthetic rendering module may associate a rendering value with a data stream (step 9200).

According to some embodiments of the present invention, the data stream routing module may be adapted to route the data stream in accordance with its associated rendering value (step 9300).

According to some embodiments of the present invention, the data stream routing module may be adapted to route the data stream to speakers output according to the associated rendering value.

According to some embodiments of the present invention, the data stream routing module may assign to the data stream routing parameters.

According to some embodiments of the present invention, the routing parameters may represent (1) the output speakers the data stream will output through, (2) the amplitude gain and/or (3) frequency filter the data stream will be applied with.

According to some embodiments of the present invention, the data stream routing module 8360 may be adapted to route the data stream using amplitude gain parameters and/or frequency filter parameters (routing parameters).

According to some embodiments of the present invention, an audio output module 8400 may be adapted to receive a data stream and routing parameters from the synthetic rendering module 8350.

According to some embodiments of the present invention, the audio output module may comprise sub modules 8410, wherein substantially each of which sub modules associated with a subset of the systems output audio speakers.

According to some embodiments of the present invention, the audio output module 8400 and/or its sub modules may be adapted to process and convert the data stream to an analog audio signal in accordance with the rendering value and the routing parameters which were associated with the data stream (step 9400).

According to some embodiments of the present invention, the audio output module and/or its sub modules may comprise of Digital to Analog components and/or analog signal mixers and/or analog signal filters and/or digital signal mixers and/or digital signal filters.

According to some embodiments of the present invention, the audio output module may be adapted to send the processed audio signal to the output speakers 8800 (step 9500).

According to some embodiments of the present invention, unit 8000 may comprise a controller 8100 and a remote control transceiver 8500.

According to some embodiments of the present invention, the aim of audio rendering is to project for each listener an audio image of remote participants in a distinct and consistent direction. The projection should be consistent for each listener but does not need to be consistent across different listeners. The projection should be clear independently of the seating position of the listener in the room.

Psychoacoustic research shows that humans derive cues of direction primarily from time differences and level differences of acoustic waves incident at the ear. For example, it is possible to record the sound field incident at the ears using microphones installed on a dummy head (to simulate head related transfer functions), and replay the recorded signals using a headset. This way, the experience at a recording room is transmitted to the listener almost perfectly. Another known class of methods, coined here ‘stereo technology’, comprises two or more microphones and loudspeakers and assumes the listener is sitting at a ‘hotspot’, equidistant from the loudspeakers. Reconstructing waveforms at the ears is more difficult in this method because (a) each ear picks up both loudspeaker signals and (b) the acoustic transfer function of the listener's head needs to be accounted for. Still, techniques to create an approximate sense of direction exist for this setup. Unfortunately, these methods break down completely when the listener is out of the hotspot. The sound collapses to the nearest loudspeaker.

According to some embodiments of the present invention, loudspeaker configurations and projection algorithms may be used to achieve direction separation that is independent of the listener position. According to yet further embodiments of the present invention, a configuration where a number of loudspeakers are positioned on a conference table in a line and each loudspeaker pair creates three virtual positions achieves optimum performance.

According to some embodiments of the present invention, these virtual positions are stable across all listeners substantially independently of their position. For example, the default product configuration has four loudspeakers creating seven stable virtual positions. There is also an additional ‘neutral’ position for which the signal is played back by all loudspeakers. In the event a signal associated with a direction is played back through multiple loudspeakers, the total power remains as if played back from a single loudspeaker.

Turning now to FIG. 9, there is shown a detailed exemplary embodiment of unit 8000. According to some embodiments of the present invention, one or more input streams may be received at each time, which input stream may be associated with input streams 8010 and 8020.

According to some embodiments of the present invention, each input stream may be associated with a node and one or more participants active at that node. For example, a node may be another RADLIVE conference room with three participants, a mobile phone, an IP phone, etc.

According to some embodiments of the present invention, substantially each stream may also be associated with a direction vector, indicating a direction index for each participant. The index may be null if no direction is associated.

According to some embodiments of the present invention, the ‘Participant2Position’ unit may assign a virtual position, the ‘Participant2Position’ unit may be associated with rendering table allocation module 8370.

According to some embodiments of the present invention, the virtual position may be associated with the translation of the routing parameters described hereinabove.

According to some embodiments of the present invention, the functionality of the ‘Participant2Position unit may be best described in correlation with data flow 10000.

Turning now to data flow 10000, there is shown the functionality of a ‘Participant2Position unit. According to some embodiments of the present invention, if there is already position in the rendering table allocated for the participant, the assigned position is that allocated.

According to some embodiments of the present invention, if a position is not assigned to the data stream in the table, a decision algorithm described herein below may assign a new position for the participant.

According to some embodiments of the present invention, when a position is allocated for a participant, the ‘Position2Speakers’ units translate that allocation to signals associated with each loudspeaker.

According to some embodiments of the present invention, the ‘Position2Speakers’ units may be associated with the data stream routing module 8360.

According to some embodiments of the present invention, substantially each loudspeaker may be associated with signals originating from a number of participants. According to yet further embodiments of the present invention, the signal may be summed up, implementing participant superposition, to calculate the final loudspeaker signals.

According to some embodiments of the present invention, the implementation of the participants superposition may be associated with the operation of the audio output module 8400 in accordance with the routing parameters.

According to some embodiments of the present invention, the system may maintain a number of databases, the databases may be updated continuously by the system throughout its operation:
1) Participant database: a database where the system stores and monitors the following:
   a) Participant load: the number of frames received so far from each participant at each node.
   b) Participant position: the currently assigned virtual position for each participant at each node.
   c) Voice print: the voice-print (or typical pitch) of each participant at each node.
2) Audio unit database: maintains the physical distance D(k,l) between audio units k and l. The distances are estimated automatically and transparently by the system at regular intervals.
3) Position database: containing
   a) Position load Lₖ: the total number of speech frames played back at position k.
   b) Position participant count Rₖ: the number of participants associated with a position.
      Position allocation is performed by choosing a position k that brings to a minimum the following metric

$${S}_{k} = {\sum }_{l = 0}^{2 ( M - 1 )} \frac{1}{D ( l , k )} \cdot ( \frac{{w}_{V}}{{V}_{l}} + {w}_{L} {L}_{l} + {w}_{R} {R}_{l} )$$

Where the coefficients WV, WL, WR are given weights, VI denotes the distance between the participant voice print and the voice prints associated with position k, and M is the number of audio units.

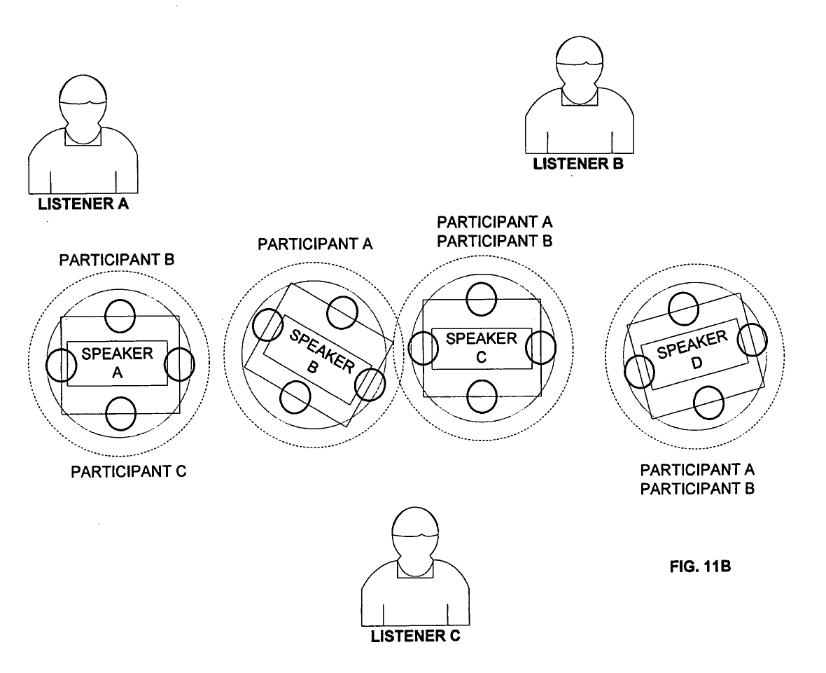

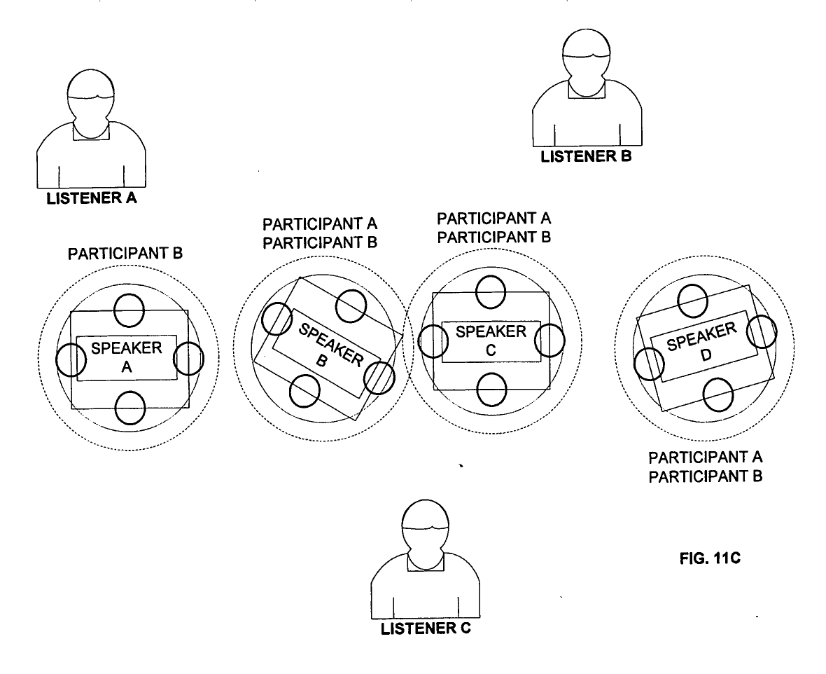

Turning now to FIGS. 11A, 11B and 11C, there is shown an exemplary permutation of speaker selection for a set of teleconference participants in accordance with some embodiments of the present invention.

According to some embodiments of the present invention, units 11300A, 11300B, 11300C, 11300D may be associated with unit 1100 of FIG. 1. According to yet further embodiments of the present invention, unit 11300A may comprise an audio speaker (SPEAKER).

According to some embodiments of the present invention, each audio speaker may output a subset of the participants in the teleconference. According to some embodiments of the present invention, the permutation of speakers chosen for a participant may be determined in accordance with an RDVI, a voice print signature and/or any other parameter which was used as a lookup parameter in the rendering table as was described hereinabove.

According to some embodiments of the present invention, an exemplary permutation of the speakers is shown in FIG. 11A, where the audio speak of unit 11300A outputs the voice signal of participant A, the audio speak of unit 11300B outputs the voice signal of participant A and C, the audio speak of unit 11300C outputs the voice signal of participant A, the audio speak of unit 11300D outputs the voice signal of participant A and B.

Other exemplary permutations are shown on FIGS. 11B and 11C.

According to some embodiments of the present invention, the system may select a permutation that will enable the listeners (11000, 11100, and 11200) in the room to receive optimum acoustic performances.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A teleconferencing system comprising:
a communication module adapted to receive packets containing a first digital data stream representing sound substantially acquired from a first sound source, the packets also including a first indicator correlated with a relative direction vector associated with the first sound source; and
a synthetic rendering module.

2. The system according to claim 1, further comprising at least two audio speakers.

3. The system according to claim 2, further comprising an audio output stage including at least one digital-to-analog (“D/A”) converter adapted to convert the first digital data stream representing sound acquired from the first sound source into a first analog signal.

4. The system according to claim 3, wherein said audio output stage further comprises a digitally configurable amplifier/switch array adapted to adjust analog signal flow between said at least one D/A and said at least two speakers.

5. The system according to claim 3, further comprising control logic adapted to configure said audio output stage based on the first indicator associated with the first sound source and based on an entry in a rendering table.

6. The system according to claim 5, wherein said communication module is adapted to receive packets including a second digital data stream representing sound acquired from a second sound source and including a second indicator associated with the second sound source.

7. The system according to claim 6, wherein substantially each entry in said rendering table includes an audio rendering configuration and said control logic is adapted to associate different data streams with different audio rendering configuration by associating indicators of different data streams with different rendering table entries.

8. The system according to claim 6, wherein said control logic is adapted to associated two or more data streams to one or more rendering entries at least partially based on speak separation parameters.

9. The system according to claim 6, wherein said control logic is adapted to associated two or more data streams from sound sources having distant voice signatures to a common rendering table entry.

10. The system according to claim 9, wherein said control logic is adapted to configure said audio output stage either adjust digital data stream flow or to adjust analog signal flow associated with different digital data streams differently.

11. The system according to claim 10, wherein said control logic is adapted to associate a given indicator with a dominant audio rendering configuration based on a priority value associated with the indicator.

12. The system according to claim 11, wherein said control logic is adapted to re-associate a given indicator with another audio rendering configuration in the event the priority value of the indicator changes.

13. The system according to claim 10, wherein said control logic is adapted to associate a given indicator with a dominant audio rendering entry based on an average data rate of the data stream with which the indicator is associated.

14. The system according to claim 13, wherein said control logic is adapted to disassociate a given indicator from an audio rendering entry in the event the average data rate of the data stream with which the indicator is associated drops below a threshold value.

15. A teleconferencing system comprising:
a communication module adapted to receive packets containing two or more digital data streams, wherein each of said two or more data stream is associated with sound acquired from at least one sound source; and a synthetic rendering module adapted to render each of said two or more data streams using a different rendering configuration.
